(19) United States
(12) Patent Application Publication
(10) Pub. No.: US 2005/0184227 A1
(43) Pub. Date: Aug. 25, 2005

(54) Method and apparatus for testing for the quality of a light transmitting/receiving structure

(75) Inventors: Wien-Haurn Kuu, Taoyuan Hsien (TW); Wei-Ming Deng, Taoyuan Hsien (TW); Di-Kuan Lin, Taoyuan Hsien (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/034,021

(22) Filed: Jan. 13, 2005

(30) Foreign Application Priority Data
Feb. 25, 2004 (TW) 93104822

(51) Int. Cl. G01J 1/04

(52) U.S. Cl. 250/227.14

(57) ABSTRACT

In a test method, an end of a testing optical fiber is first coupled to a light transmitting/receiving structure. The testing optical fiber and the light transmitting/receiving structure are then fixed, and the testing optical fiber is passed through the opening of a defining structure. Next, the testing optical fiber is moved within a testing zone defined by the opening, and variations of the strength of an optical signal transmitted in the testing optical fiber are measured. Finally, the quality of the light transmitting/receiving structure is judged according to the variations. The test apparatus includes the securing structure, the defining structure, and a testing structure.

### RELATED APPLICATIONS

The present application is based on, and claims priority from, Taiwan Application Serial Number 93104822, filed Feb. 25, 2004, the disclosure of which is hereby incorporated by reference herein in its entirety.

### BACKGROUND OF THE INVENTION

1. Field of Invention

The present invention relates to testing for the quality of a light transmitting/receiving structure. More particularly, the present invention relates to a method and apparatus for testing for the quality of a light transmitting/receiving structure by determining whether the optical signal transmission path thereof deviates or not.

2. Description of Related Art

In the field of data communications, optoelectronic transceivers act as the interface between electrical and optical transmission media. Optical transmitters convert electrical data signals into optical signals, which may be transferred over fiber optic cables. Conversely, optical receivers receive optical signals and convert them into electrical signals. Each optical transmitter and optical receiver can be a separate device, or they may be combined into a single device to form an optoelectronic transceiver.

A key element of any optical transmitter or receiver is an optical subassembly. In the case of an optical transmitter, an optical subassembly may comprise a transmitting optical subassembly (TOSA); while in the case of an optical receiver, an optical subassembly may comprise a receiving optical subassembly (ROSA).

Taking a TOSA as an example, the TOSA provides the physical structure to couple the optical output signal of the transmitter to an optical fiber and acts to align and focus the optical signal onto the end of the optical fiber such that the optical signal enters the optical fiber and is transmitted to a remote location.

FIG. 1A illustrates the assembly of the components of a TOSA to form a light transmitting/receiving structure. The TOSA 10 includes an optical package 20, a cylindrical holding barrel 26 and a ferrule 30. The optical package 20 has an optical or optoelectronic component 21. FIG. 1B is a magnified cross-section of the ferrule 30. The ferrule 30 includes an axial hole 34, a fiber stop 32, and a C-ring 36.

In traditional manufacturing processes, components of a light transmitting/receiving structure have inherent flaws that frequently cause deviations in the optical signal transmission path of the structure after being assembled. The light transmitting/receiving structure thus produced is of poor quality. With respect to the TOSA 10, possible causes of deviations in the optical signal transmission path include misalignment of the optical axis of the optical or optoelectronic component 21, improper location of a focusing element (not shown in FIG. 1A), loose or slack connection between the optical package 20 and the holding barrel 26, loose connection between the holding barrel 26 and the ferrule 30, failure of the C-ring 36 to firmly grasp the optical fiber that is inserted into the axial hole 34, inadequate core concentricity of the fiber stop 32, and failure of the ferrule 30 to firmly grasp the fiber stop 32. In light of these problems, the quality of a finished or semi-finished light transmitting/receiving structure product is likely to be poor. In addition, the reliability of a finished or semi-finished product cannot be controlled without a pretest mechanism, and consequently, the product yield is uncertain.

### SUMMARY OF THE INVENTION

It is therefore an objective of the present invention to provide a method of testing for the quality of a light transmitting/receiving structure to improve the reliability thereof.

It is another objective of the present invention to provide an apparatus for testing for the quality of a light transmitting/receiving structure to ensure that the light transmitting/receiving structure during manufacturing stages has good quality and reliability.

It is still another objective of the present invention to provide a method of testing for the quality of a light transmitting/receiving structure so as to reduce the manufacturing cost thereof.

Accordingly, the invention provides a method of testing for the quality of a light transmitting/receiving structure. This method includes the following steps. First, an end of a testing optical fiber is coupled to the light transmitting/receiving structure. The testing optical fiber and the light transmitting/receiving structure are then fixed on a securing structure, and the testing optical fiber is passed through a testing zone, and the optical signal transmission path of the light transmitting/receiving structure is coaxially positioned with the testing zone. Next, the testing optical fiber is moved within the testing zone, and variations of the strength of an optical signal transmitted in the testing optical fiber are measured. Finally, the quality of the light transmitting/receiving structure is judged according to the variations.

The invention also provides an apparatus for testing for the quality of a light transmitting/receiving structure. This apparatus includes a securing structure, a defining structure, and a testing structure. The securing structure is used to hold the light transmitting/receiving structure. The opening of the defining structure defines a testing zone, and the geometric axis of the testing zone is coaxially positioned with a predetermined light transmitting/receiving path in the securing structure. The testing structure includes a testing optical fiber. An end of the testing optical fiber is passed through the testing zone and coupled to the light transmitting/receiving structure.

Advantages of employing the invention include the following. During different manufacturing processes of a light transmitting/receiving structure, performing the test method can help to successfully and quickly determine whether the optical signal transmission path of the light transmitting/receiving structure deviates or not. By said method, a bad light transmitting/receiving structure can be found and improved on time, thereby the yield of the light transmitting/receiving structure can be further increased. In addition, the test method can be performed before, during, or after assembly of the components that comprise the light transmitting/receiving structure; and therefore, the quality of the light transmitting/receiving structure can be monitored and maintained during every manufacturing stage in order to increase product yield.

### BRIEF DESCRIPTION OF THE DRAWINGS

These and other features, aspects, and advantages of the present invention will become better understood with regard to the following description, appended claims, and accompanying drawings where:

FIG. 1A illustrates the assembly of components of a TOSA to form a light transmitting/receiving structure;

FIG. 1B is a magnified cross-section of the ferrule in FIG. 1A;

FIG. 2 illustrates a configuration for performing the test method of the invention;

FIG. 3 illustrates a partial apparatus used for testing a light transmitting/receiving structure according to an embodiment of the invention;

FIG. 4 illustrates a configuration for testing the quality of the TOSA of FIG. 1A by using the partial apparatus of FIG. 3;

FIG. 5 illustrates the components of an exemplary holding structure of the partial apparatus in FIG. 3; and

FIG. 6A-6D illustrate different shapes of the testing zone defined by the opening of the defining structure of the testing apparatus of the invention.

### DESCRIPTION OF THE PREFERRED EMBODIMENTS

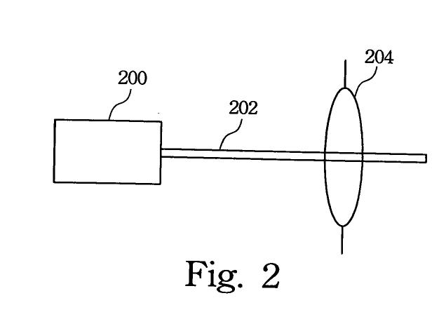

The present invention provides a method of testing the quality of a light transmitting/receiving structure, which is described below. The method is used to substantially increase the quality and reliability of a light transmitting/receiving structure. The light transmitting/receiving structure is the object to be tested, and can be, for example, an optical subassembly, an optical or optoelectronic component, an optical package, an optical fiber, or a transceiver module. FIG. 2 illustrates a configuration for performing the test method, the steps of which are described as follows. First, an end of a testing optical fiber 202 is coupled to a light transmitting/receiving structure 200. The testing optical fiber 202 and the light transmitting/receiving structure 200 are then fixed, and the testing optical fiber 202 is passed through a testing zone, and the optical signal transmission path of the light transmitting/receiving structure 200 is coaxially positioned with the testing zone. Next, the testing optical fiber 202 is moved within the testing zone. For instance, the testing optical fiber 202 is moved up and down or forward and backward, or moved around the testing zone. Alternatively, the testing optical fiber 202 may be rotated, which changes the coupling orientation between the testing optical fiber 202 and the light transmitting/receiving structure 200. Next, variations of the strength of an optical signal transmitted in the testing optical fiber 202 are measured. Finally, the quality of the light transmitting/receiving structure 200 is judged according to the variations.

The light transmitting/receiving structure 200 may comprise an optical or optoelectronic component such as an LED, a semiconductor laser (or laser diode), or a photodiode. In addition, the securing structure described above may also comprise a holding structure that is used to hold the light transmitting/receiving structure 200. Furthermore, the variations of the strength of the optical signal are measured by using, for example, an optical power measuring device. In particular, when the light transmitting/receiving structure 200 is a light transmitting structure, the optical power measuring device is connected to the testing optical fiber 202. When the light transmitting/receiving structure 200 is a light receiving structure, the optical power measuring device is connected to the light transmitting/receiving structure 200, while the testing optical fiber 202 is connected to a light source.

When the light transmitting/receiving structure 200 transmits an optical signal, a strength of the optical signal transmitted from the light transmitting/receiving structure 200 to the testing optical fiber 202 is measured. In order to judge the quality of the light transmitting/receiving structure 200, a tolerable error range in which the measured optical signal strength variations should be set according to the strength of the optical signal that is transmitted by the light transmitting/receiving structure 200. If the measured optical signal strength approaches the strength of the optical signal that is transmitted by the light transmitting/receiving structure 200, and is within the acceptable error range, the light transmitting/receiving structure 200 is judged to be of good quality. On the contrary, if the measured optical signal strength is not within the acceptable error range, the light transmitting/receiving structure 200 is judged to be of bad quality.

Furthermore, in order to assess the quality of the testing optical fiber 202 itself, a standard testing optical fiber may be used as the light transmitting/receiving structure 200, and the testing method can be performed as described above.

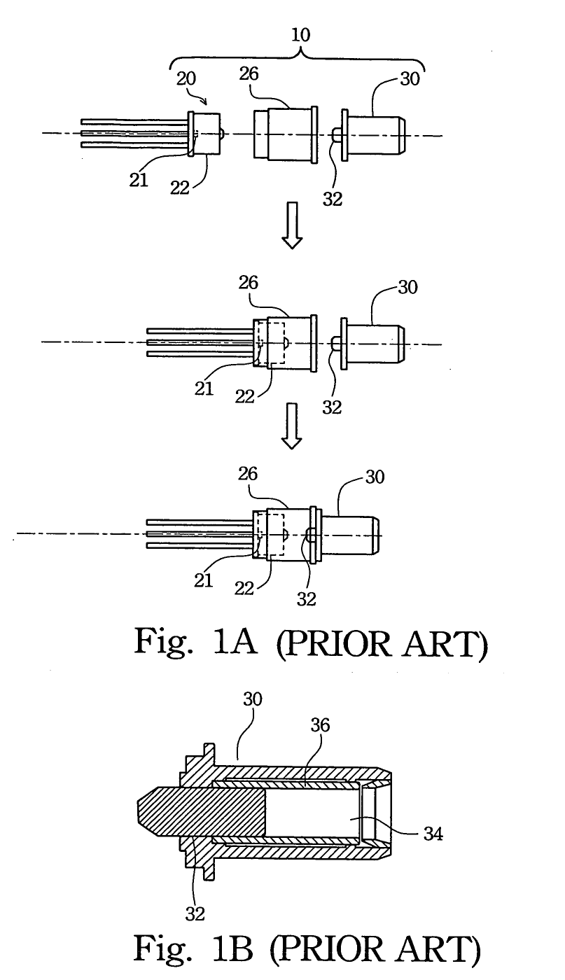

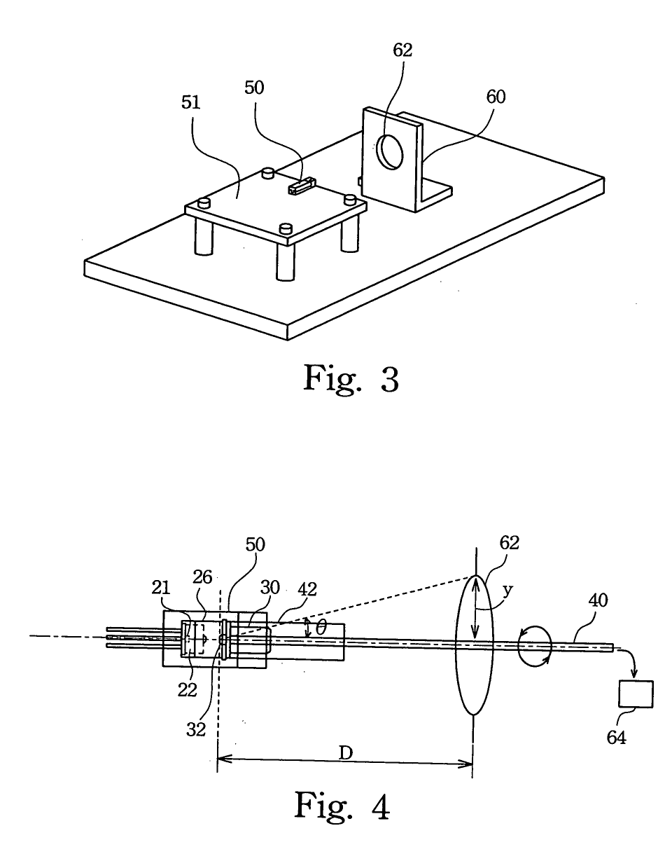

According to an embodiment of the present invention, a method is performed to test the TOSA 10, a light transmitting/receiving structure, shown in FIG. 1A. FIG. 3 illustrates a partial apparatus used for performing the test. FIG. 4 illustrates a configuration for testing the quality of the TOSA 10 by using the partial apparatus shown in FIG. 3.

The partial apparatus in FIG. 3 includes a securing structure 51 and a defining structure 60. The securing structure 51 further includes a holding structure 50 used for holding the light transmitting/receiving structure. The physical shape of the holding structure 50 depends on the shape of the light transmitting/receiving structure. An opening 62 of the defining structure 60 defines a testing zone, and the geometric axis of the testing zone is coaxially positioned with a predetermined light transmitting/receiving path in the securing structure 51. In this embodiment, the shape of the opening 62 and the testing zone defined by it is a circle. The testing apparatus further includes a testing structure. The testing structure in this embodiment comprises a testing optical fiber. An end of the testing optical fiber may be connected to an optical detector or a light source. The testing optical fiber is, for example, a standard testing optical fiber or a calibrated optical fiber.

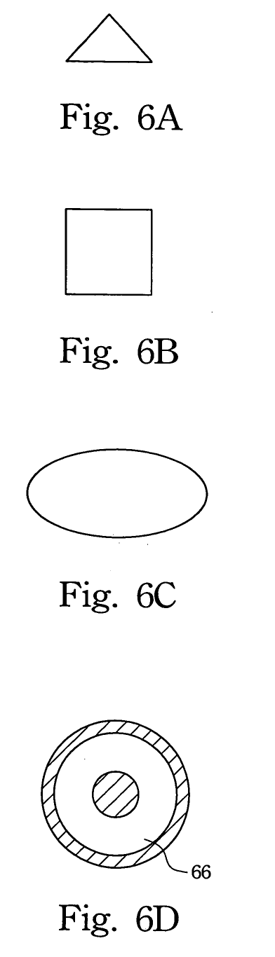

In addition, the shape of the testing zone defined by the opening of the defining structure may be other shapes. The shape of the testing zone may be a polygon, as exemplified by the triangle and quadrilateral in FIG. 6A and FIG. 6B, respectively. The shape of the testing zone may also be an ellipse or a ring as shown in FIG. 6C and FIG. 6D, respectively. In FIG. 6D, the shape of the testing zone defined by the opening of the defining structure is a ring area 66 similar to a circular channel. The testing zone is not necessarily a closed area.

Using the TOSA 10 as an example of a light transmitting/receiving structure, the embodiment of the present invention is further explained as follows. With reference to FIGS. 1A, 3, and 4, the TOSA 10 includes the optical package 20, the cylindrical holding barrel 26, and the ferrule 30. A can-shaped cover, called the TO can 22, of the optical package 20 covers the optical or optoelectronic component 21. In this embodiment, the optical or optoelectronic component 21 is a light-emitting component, for example an LED or a semiconductor laser. An end of the holding barrel 26 receives the optical package 20, and the optical package 20 is fastened to the inside of the holding barrel 26 by a means such as gluing or welding. The other end of the holding barrel 26 receives the ferrule 30, which is used to connect and position an external optical fiber. The C-ring 36 shown in FIG. 1B inside the ferrule 30 is used for grasping the external optical fiber. Additionally, the fiber stop 32 may be placed inside the ferrule 30 to increase the usefulness and stability of the ferrule 30. In order to focus and reduce the loss of the optical signal emitted by the optical or optoelectronic component 21 on an end of the fiber stop 32, a focusing element may be used between the optical or optoelectronic component 21 and the fiber stop 32. Furthermore, the TOSA 10 usually connects to the external optical fiber through a fiber optic connector 42. In this preferred embodiment, a testing optical fiber 40 is used as the external optical fiber.

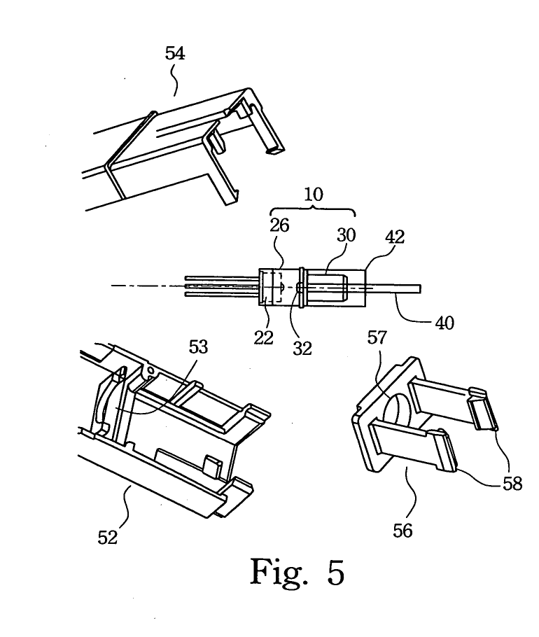

As shown in FIG. 5, the holding structure 50 includes an upper cover 54, a gripper 56, and a lower cover 52. The lower cover 52 has an engaging indentation 53 used for engaging with the TOSA 10. The gripper 56 has a hole 57 and two gripping arms 58. The TOSA 10 passes through the hole 57 and connects to the testing optical fiber 40, while the two gripping arms 58 grip the fiber optic connector 42 to secure the testing optical fiber 40 firmly. The physical shape of the two gripping arms 58 depends on the shape of the fiber optic connector 42. The upper cover 54 and the lower cover 52 attach to, enclose, and secure the TOSA 10, the gripper 56, and the fiber optic connector 42. The components of the holding structure 50 can be separately, partially assembled, or integrally formed as a single piece. If the holding structure 50 is not employed, other methods can be used to fix the testing optical fiber 40 and the TOSA 10 on the securing structure 51. Also, when the light transmitting/receiving structure itself can hold and secure the testing optical fiber 40, the holding structure 50 can be converted to have a shape suitable for holding the light transmitting/receiving structure. In this case, the holding structure 50 can have, for example, clasps and hooks.

With reference to FIG. 4, the predetermined light transmitting/receiving point in the holding structure 50 coincides with the point of light transmitting/receiving in the light transmitting/receiving structure (TOSA 10) when being held by the holding structure 50. In this case, a movement angle θ is defined between a line from the point of light transmitting/receiving to the center of the opening 62 and a line extending from the point of light transmitting/receiving to an edge of the opening 62. The movement angle θ can be specified as needed and is preferably in the range of 5 degrees to 13 degrees. In this embodiment, the movement angle θ is about 8.9 degrees. If the movement angle θ is larger, the external mechanical force that can be tolerated by a light transmitting/receiving structure with good quality is larger.

In another aspect, there is a maximum distance y between the circumference and the center of the opening 62, and there is a distance D between the point of light transmitting/receiving and the center of the testing zone. The quotient when the maximum distance y is divided by the distance D is in the range of about 0.08 to about 0.25. Changing the maximum distance y and/or the distance D changes the ratio of the maximum distance y to the distance D. In this embodiment, the distance D is 48 mm, the maximum distance y is 7.5 mm; and therefore, the ratio is about 0.156. If the ratio is larger, the external mechanical force that can be tolerated by a light transmitting/receiving structure with good quality is larger.

The procedures of the testing method performed in this embodiment are described in detail as follows. First, the testing optical fiber 40 is coupled to the TOSA 10 to make an end of the testing optical fiber 40 contact the fiber stop 32, in order to make the optical signal transmission path of the TOSA 10 pass through the fiber stop 32.

The testing optical fiber 40 and the TOSA 10 are then fixed on the securing structure 51 by using the holding structure 50 of the securing structure 51 to grasp the TOSA 10 and the fiber optic connector 42. Simultaneously, the testing optical fiber 40 is passed through the opening 62, which defines the testing zone, of the defining structure 60 such that the optical signal transmission path of the TOSA 10 is coaxially positioned with the testing zone.

Next, the free end of the testing optical fiber 40 is coupled to an optical detector. In this embodiment, the optical detector is an optical power measuring device 64, which is, for example, a power meter. Alternatively, when the TOSA 10 is replaced with a different kind of light transmitting/receiving structure, a light source may, if needed, be used instead of the optical detector, or the optical detector and the light source may be used together. In this case, the testing apparatus further includes the light source. During the test, the light source is coupled to the free end of the testing optical fiber and sends light into the testing optical fiber. At the same time, the optical detector is coupled to the light transmitting/receiving structure and is used for measuring variations of the strength of an optical signal received by the light transmitting/receiving structure.

Next, the testing optical fiber 40 is moved within the testing zone, and variations of the strength of an optical signal transmitted in the testing optical fiber 40 are measured. The quality of the TOSA 10 is judged according to the variations. In order to judge the quality of the TOSA 10, a tolerable error range in which the measured optical signal strength variations can lie should be set according to the strength of the optical signal transmitted by the TOSA 10. If the measured optical signal strength variations lie within the error range, the TOSA 10 is deemed to be of good quality. Otherwise, the TOSA 10 is deemed to be of bad quality.

Moving the testing optical fiber 40 within the testing zone may include moving the testing optical fiber 40 up and down, right and left, or forward and backward; or moving the testing optical fiber 40 clockwise or counterclockwise around the circumference of the opening 62. This manner of moving the testing optical fiber 40 while measuring the optical signal strength can in the main test if the optical signal transmission path of the TOSA 10 deviates as a result of applied mechanical force, which results in bad quality.

Moving the testing optical fiber 40 within the testing zone may alternatively include rotating the testing optical fiber 40 to change the coupling orientation between the testing optical fiber 40 and the TOSA 10. This manner of moving the testing optical fiber 40 can in the main test for the concentricity of the TOSA 10 and test if the optical signal transmission path deviates, which results in bad quality. The angle of rotation of the testing optical fiber 40 may be a ranged from 0 degree to 360 degrees.

The invention further includes a method for testing for the quality of a testing optical fiber. In this method, a standard optical fiber is used as the light transmitting/receiving structure, and then the same steps as described above are performed to test for the quality of the testing optical fiber before testing another light transmitting/receiving structure, thereby validating that the test method is accurate. When determining the quality of the testing optical fiber, the standard optical fiber can be arranged to transmit (or receive) an optical signal, and the testing optical fiber is then arranged to receive (or transmit) the optical signal. The quality of the testing optical fiber is then judged according to the measured optical signal strength variations.

It should be noted that the invention could be used to test various kinds of light transmitting/receiving structure, such as an optical subassembly, an optical or optoelectronic component, an optical package, an optical fiber, and a transceiver module. The optical or optoelectronic component may be an LED, a semiconductor laser, or a photodiode.

Advantages of employing the invention include the following. During different manufacturing processes of a light transmitting/receiving structure, performing the test method can help determine whether the optical signal transmission path of the light transmitting/receiving structure deviates or not. When a light transmitting/receiving structure with bad quality is discovered by the test method, manufacturing processes can be improved at once and in time to improve the quality of subsequently manufactured light transmitting/receiving structures, thereby increasing yield. In addition, the test method can be performed before, during, or after assembly of the components comprising the light transmitting/receiving structure such that the quality of the light transmitting/receiving structure during every manufacturing stage can be maintained and the product yield can be improved.

Although the present invention has been described in considerable detail with reference to certain preferred embodiments thereof, other embodiments are possible. Therefore, the spirit and scope of the appended claims should not be limited to the description of the preferred embodiments contained herein.

1. A method of testing for the quality of a light transmitting/receiving structure, said method comprising:
coupling an end of a testing optical fiber to said light transmitting/receiving structure;
fixing said testing optical fiber and said light transmitting/receiving structure and passing said testing optical fiber through a testing zone, wherein an optical signal transmission path of said light transmitting/receiving structure is coaxially positioned with said testing zone;
moving said testing optical fiber within said testing zone and measuring variations of the strength of an optical signal transmitted in said testing optical fiber; and
judging the quality of the light transmitting/receiving structure according to said variations.

2. The method of claim 1, wherein the step of moving said testing optical fiber within said testing zone comprises moving said testing optical fiber up and down, right and left, or forward and backward, or moving said testing optical fiber clockwise or counterclockwise around the circumference of said opening.

3. The method of claim 1, wherein the step of moving said testing optical fiber within said testing zone comprises rotating said testing optical fiber to change the coupling orientation between said testing optical fiber and said light transmitting/receiving structure.

4. The method of claim 3, wherein an angle of rotation of said testing optical fiber is a ranged from 0 degree to 360 degrees.

5. The method of claim 1, wherein the shape of said testing zone is a circle, a polygon, a ring, or an ellipse.

6. The method of claim 1, wherein said light transmitting/receiving structure is an optical subassembly, an optical or optoelectronic component, an optical package, an testing optical fiber, or a transceiver module.

7. The method of claim 6, wherein said optical or optoelectronic component is an LED, a semiconductor laser, or a photodiode.

8. The method of claim 6, further comprising judging the quality of said testing optical fiber according to said variations when said light transmitting/receiving structure is a standard optical fiber.

9. The method of claim 1, wherein said variations are measured by using an optical power measuring device.

10. An apparatus for testing for the quality of a light transmitting/receiving structure, said apparatus comprising:
a securing structure, for securing said light transmitting/receiving structure;
a defining structure, having a testing zone being coaxially positioned with a predetermined light transmitting/receiving path in said securing structure; and
a testing structure, said testing structure having a testing optical fiber, an end of said testing optical fiber being passed through said testing zone and coupled to said light transmitting/receiving structure.

11. The apparatus of claim 10, wherein said testing structure further comprises an optical detector for measuring variations of a strength of an optical signal transmitted by said light transmitting/receiving structure.

12. The apparatus of claim 11, wherein said optical detector is coupled to another end of said testing optical fiber.

13. The apparatus of claim 11, further comprising a light source, said light source being coupled to another end of said testing optical fiber.

14. The apparatus of claim 13, wherein said optical detector is coupled to said light transmitting/receiving structure and is used for measuring variations of the strength of an optical signal received by said light transmitting/receiving structure.

15. The apparatus of claim 10, wherein said light transmitting/receiving point coincides with the point of light transmitting/receiving in said light transmitting/receiving structure when being held by said securing structure.

16. The apparatus of claim 15, wherein said line and an extension line from said light transmitting/receiving point to an edge of said testing zone define a movement angle.

17. The apparatus of claim 16, wherein said movement angle is ranged from 5 degrees to 13 degrees.

18. The apparatus of claim 15, wherein a maximum distance between the circumference and the center of said testing zone divided by a distance between said light transmitting/receiving point and the center of said testing zone is in the range of 0.08 to 0.25.

19. The apparatus of claim 10, wherein the shape of said testing zone is a circle, a polygon, a ring, or an ellipse.

20. The apparatus of claim 10, wherein said light transmitting/receiving structure is an optical subassembly, an optical or optoelectronic component, an optical package, an optical fiber, or a transceiver module; and wherein said optical or optoelectronic component is an LED, a semiconductor laser, or a photodiode.
